(19) United States
(12) Patent Application Publication
(10) Pub. No.: US 2026/0097653 A1
(43) Pub. Date: Apr. 9, 2026

(54) SIGHT-LINE GUIDANCE APPARATUS, SIGHT-LINE GUIDANCE METHOD, AND RECORDING MEDIUM

(71) Applicant: HONDA MOTOR CO., LTD., Tokyo (JP)

(72) Inventors: Yuichiro Shimura, Wako-shi (JP); Toshihiro Hashimoto, Wako-shi (JP)

(21) Appl. No.: 19/343,782

(22) Filed: Sep. 29, 2025

(30) Foreign Application Priority Data
Oct. 9, 2024 (JP) 2024-177070

(51) Int. Cl. B60K 35/28; B60K 35/233

(52) U.S. Cl. CPC B60K 35/285; B60K 35/233; B60K 2360/1868; B60K 2360/785

(57) ABSTRACT

A sight-line guidance apparatus is a sight-line guidance apparatus that guides a line of sight of a driver of a vehicle, and includes: a first detection unit that detects a target existing in front of the vehicle; and a display control unit that displays a sight-line guidance sign on a windshield of the vehicle when the first detection unit detects the target. The sight-line guidance sign guides the line of sight of the driver to the target. The display control unit displays the sight-line guidance sign in such a manner that the sight-line guidance sign moves from a display start position of the sight-line guidance sign toward the target in accordance with a change in movement speed. The change is made based on a degree of risk that is a degree of probability of the vehicle coming into contact with the target.

### INCORPORATION BY REFERENCE

The present application claims priority under 35 U.S.C. § 119 to Japanese Patent Application No. 2024-177070 filed on Oct. 9, 2024. The content of the application is incorporated herein by reference in its entirety.

### BACKGROUND OF THE INVENTION

### Field of the Invention

The present invention relates to a sight-line guidance apparatus, a sight-line guidance method, and a recording medium.

### Description of the Related Art

In recent years, research and development related to the visibility of a vehicle driver has been conducted to be able to contribute to further improvement in traffic safety and development of sustainable transportation systems. Conventionally, there has been known a technology of guiding the line of sight of a vehicle driver, as a technology related to the visibility of a vehicle driver. For example, Japanese Patent Laid-Open No. 2017-187955 discloses a sight-line guidance apparatus that guides the line of sight of a driver toward a target by moving a vision stimulus displayed on a windshield.

Japanese Patent Laid-Open No. 2017-187955 also discloses that moving speed at which the vision stimulus is moved is increased as an angle formed by the target and the line of sight increases.

However, according to Japanese Patent Laid-Open No. 2017-187955, since a configuration is made such that a similar time period is used to move the vision stimulus to the target, regardless of the distance between the point of sight of the driver and the target, it is difficult for the driver to perceive from the vision stimulus how high the risk of coming into contact with the target is. Accordingly, with the configuration of Japanese Patent Laid-Open No. 2017-187955, it is difficult for the driver to perceive what situation the own vehicle is in, in terms of contact with the target.

Accordingly, the present invention has been made in view of the circumstances as described above, and an object thereof is to make it possible for a driver to perceive what situation the own vehicle is in, in terms of contact with a target.

### SUMMARY OF THE INVENTION

An aspect of the present invention is a sight-line guidance apparatus that guides a line of sight of a driver of a vehicle, including: a first detection unit that detects a target existing in front of the vehicle; and a display control unit that displays a sight-line guidance sign on a windshield of the vehicle when the first detection unit detects the target, the sight-line guidance sign guiding the line of sight of the driver to the target, wherein the display control unit displays the sight-line guidance sign in such a manner that the sight-line guidance sign moves from a display start position of the sight-line guidance sign toward the target in accordance with a change in movement speed, the change being made based on a degree of risk that is a degree of probability of the vehicle coming into contact with the target.

According to the aspect of the present invention, a driver can perceive what situation the own vehicle is in, in terms of contact with a target.

### BRIEF DESCRIPTION OF THE DRAWINGS

FIG. 1 shows a configuration in a vehicle cabin of a vehicle;

FIG. 2 shows a configuration of the vehicle;

FIG. 3 is a diagram for describing processing by a display control unit;

FIG. 4 is a diagram for describing determination of a second movement end position;

FIG. 5 shows an example of movement of a sight-line guidance sign;

FIG. 6 shows an example of movement of the sight-line guidance sign;

FIG. 7 shows an example of movement of the sight-line guidance sign;

FIG. 8 is a diagram for describing moving-back of the sight-line guidance sign; and

FIG. 9 is a flowchart showing operation of a sight-line guidance apparatus.

### DETAILED DESCRIPTION OF THE INVENTION

### 1. Configuration of Vehicle

Hereinafter, an embodiment will be described with reference to the drawings.

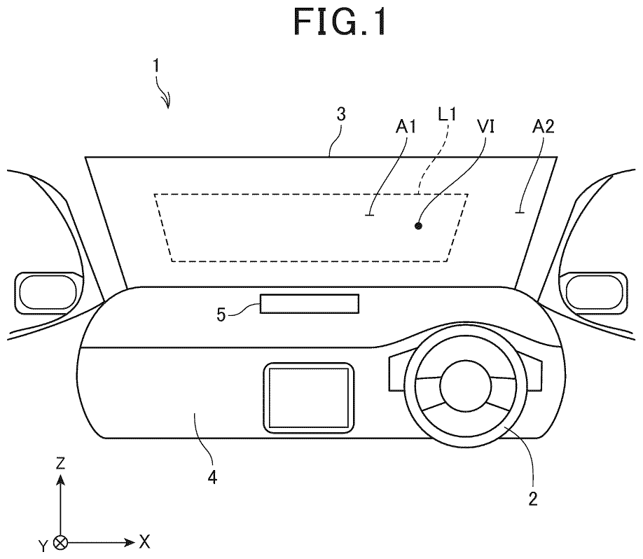

In FIGS. 1 and 3 to 8, an X-axis, a Y-axis, and a Z-axis are shown. The X-axis, the Y-axis, and the Z-axis are orthogonal to each other. The Z-axis indicates an up-down direction. The X-axis and the Y-axis are parallel to a horizontal direction in a state where a vehicle 1 is traveling. The X-axis indicates a right-left direction as a vehicle width direction. The Y-axis indicates a front-rear direction. A positive direction of the X-axis indicates a rightward direction. A positive direction of the Y-axis indicates a forward direction. A positive direction of the Z-axis indicates an upward direction.

FIG. 1 shows a configuration in a vehicle cabin of the vehicle 1.

For the vehicle 1 in the present embodiment, a four-wheel automobile is illustrated.

In the vehicle cabin of the vehicle 1, a steering wheel 2 for steering the vehicle 1, a windshield 3 that separates the inside of the vehicle cabin from the outside, and an instrument panel 4 are installed. The steering wheel 2 is installed in the instrument panel 4 at a position facing a driver U sitting in a driver seat.

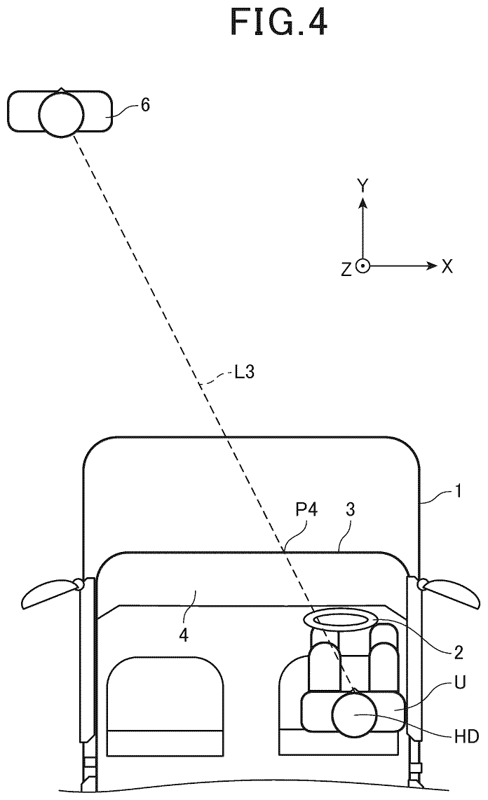

A HUD (Head Up Display) 5 is provided in the instrument panel 4. The HUD 5 displays a sight-line guidance sign VI that guides the line of sight of the driver U (see FIG. 4) to a target 6 (for example, see FIG. 4) by projecting light onto the windshield 3. The sight-line guidance sign VI is a virtual image. The target 6 refers to a target object to which it is preferable to direct the line of sight of the driver U. The HUD 5 displays the sight-line guidance sign VI on the windshield 3, whereby the driver U sitting in the driver seat can see the sight-line guidance sign VI together with a scene in front of the vehicle 1 through the windshield 3.

Note that FIG. 1 illustrates a circle as a shape of the sight-line guidance sign VI. However, the shape of the sight-line guidance sign VI shown in FIG. 1 is only an example, and may also be, for example, a rectangle or a star shape.

In FIG. 1, a display-allowed area A1 in which the sight-line guidance sign VI can be displayed is depicted as an area enclosed by a dotted line L1. The size of the display-allowed area A1 corresponds to the size of a magnifying mirror (concave mirror) included in the HUD 5. Note that the size of the display-allowed area A1 relative to the windshield 3 is not limited to the size shown in FIG. 1. Moreover, although FIG. 1 shows such a shape that the longer-side direction of the display-allowed area A1 is the vehicle width direction, the shape of the display-allowed area A1 is not limited to the shape shown in FIG. 1.

The display-allowed area A1 corresponds to “first area”.

Moreover, a display-disallowed area A2 in which the sight-line guidance sign VI is not displayed is depicted in FIG. 1. In FIG. 1, the display-disallowed area A2 is the area of the windshield 3 excluding the display-allowed area A1.

The display-disallowed area A2 corresponds to “second area”.

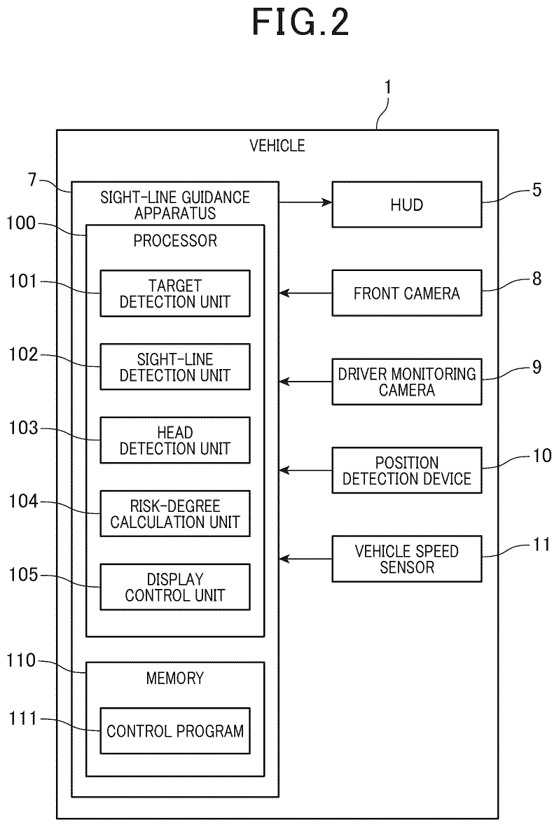

FIG. 2 shows a configuration of the vehicle 1.

The vehicle 1 includes a sight-line guidance apparatus 7. The sight-line guidance apparatus 7 includes a processor 100, such as a CPU (Central Processing Unit) or an MPU (Micro-Processing Unit), and memory 110.

The processor 100 controls each unit of the sight-line guidance apparatus 7 by reading and executing a control program 111 stored in the memory 110. The processor 100 functions as a target detection unit 101, a sight-line detection unit 102, a head detection unit 103, a risk-degree calculation unit 104, and a display control unit 105 by executing the control program 111 stored in the memory 110.

The target detection unit 101 corresponds to “first detection unit”. The sight-line detection unit 102 corresponds to “second detection unit”.

The memory 110 is a storage device that stores a program to be executed by the processor 100 and data to be processed by the processor 100. The memory 110 stores the control program 111 to be executed by the processor 100 and other various data. The memory 110 includes a non-volatile storage area. Moreover, the memory 110 includes a volatile storage area, which constitutes a work area for the processor 100. The memory 110 is configured by using, for example, a ROM (Read Only Memory) and a RAM (Random Access Memory).

The control program 111 corresponds to “program”.

The HUD 5, a front camera 8, a driver monitoring camera 9, a position detection device 10, and a vehicle speed sensor 11 are connected to the sight-line guidance apparatus 7. Note that devices connected to the sight-line guidance apparatus 7 are not limited to those mentioned above, and a vehicle-to-vehicle communication apparatus for vehicle-to-vehicle communication and other devices, such as a GNSS (Global Navigation Satellite System) unit and a rear camera, may be connected.

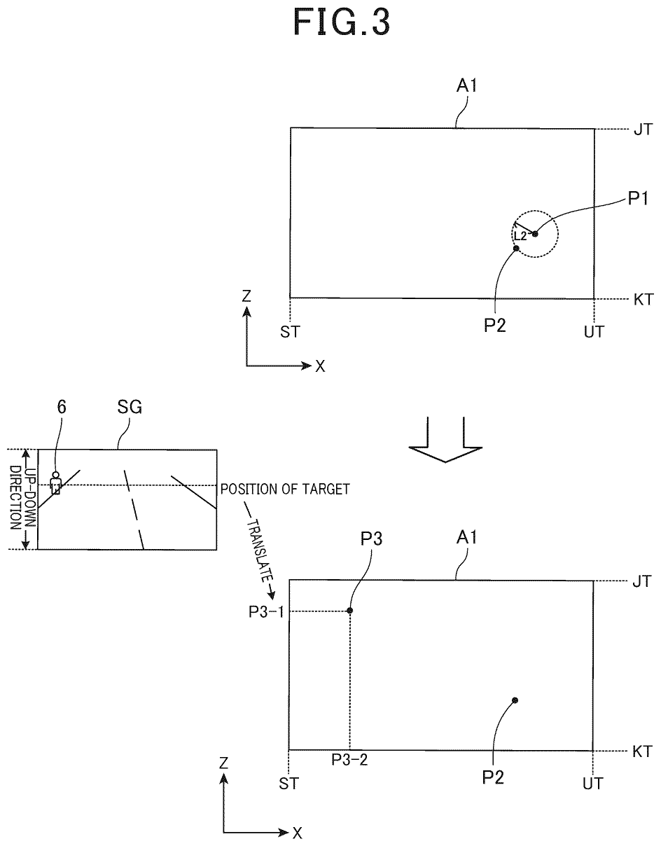

The front camera 8 is a camera installed at a predetermined position in the vehicle 1 and capturing a scene in front of the vehicle 1. The front camera 8 performs capturing in each predetermined period when an ignition of the vehicle 1 is on, when an accessory power supply of the vehicle 1 is on, or the like. Each time the front camera 8 performs capturing, the front camera 8 outputs image data on a captured image SG (see FIG. 3) acquired by the capturing to the sight-line guidance apparatus 7.

The driver monitoring camera 9 is a camera installed at a predetermined position in the vehicle cabin of the vehicle 1 and capturing the driver U sitting in the driver seat. The capturing range of the driver monitoring camera 9 is a range including at least a head HD (see FIG. 4) of the driver U sitting in the driver seat. The driver monitoring camera 9 performs capturing in each predetermined period when the ignition of the vehicle 1 is on, when the accessory power supply of the vehicle 1 is on, or the like. Each time the driver monitoring camera 9 performs capturing, the driver monitoring camera 9 outputs image data on a captured image acquired by the capturing to the sight-line guidance apparatus 7.

The position detection device 10 is a device that can detect a position of an object existing around the vehicle 1. The position detection device 10 is configured by using at least one or more of, for example, a sonar, a radar, lidar, all of which can measure the distance between the vehicle 1 and the object, a stereo camera, which can measure the distance between the vehicle 1 and the object by using parallax, and the like.

The vehicle speed sensor 11 is a sensor that detects the speed of the vehicle 1. The vehicle speed sensor 11 detects the speed of the vehicle 1 in each predetermined period. Each time the vehicle speed sensor 11 detects a speed, the vehicle speed sensor 11 outputs a signal corresponding to the detected speed of the vehicle 1 to the sight-line guidance apparatus 7.

As mentioned above, the processor 100 of the sight-line guidance apparatus 7 functions as the target detection unit 101, the sight-line detection unit 102, the head detection unit 103, the risk-degree calculation unit 104, and the display control unit 105.

### 1-1. Target Detection Unit

The target detection unit 101 detects a target 6 existing in front of the vehicle 1. The target detection unit 101 detects the target 6 appearing in a captured image SG acquired by capturing by the front camera 8, based on image data on the captured image SG received from the front camera 8. As mentioned above, the target 6 refers to a target object to which the line of sight of the driver U should be directed. Specific examples of the target 6 include a pedestrian, another vehicle, a fixed object, and the like. Examples of the fixed object include road signs, delineators, and the like. The target detection unit 101 detects the target 6 appearing in the captured image SG by performing pattern matching or color-based image processing on the captured image SG. Note that data (for example, shape data or color data) required to detect the target 6 is stored in the memory 110 by type of target 6 to be detected.

Moreover, the target detection unit 101 detects a position of the detected target 6. More specifically, the target detection unit 101 detects the relative position of the detected target 6 with respect to the vehicle 1 when the vehicle 1 is viewed from above. The target detection unit 101 detects the relative position of the detected target 6, based on at least any one of a result of detection by the position detection device 10 and the captured image SG from the front camera 8. Note that when the detected target 6 is another vehicle and when a vehicle-to-vehicle communication apparatus and a GNSS unit are connected to the sight-line guidance apparatus 7, the target detection unit 101 may detect the relative position of the detected target 6, based on the position of the other vehicle received by the vehicle-to-vehicle communication apparatus and the position of the vehicle 1 received by the GNSS unit.

Note that apart from the front camera 8, the vehicle-to-vehicle communication apparatus, and the GNSS unit, the target detection unit 101 may use V2X (road-to-vehicle, vehicle-to-pedestrian, or the like) communication, determination in a virtual environment via a server, or the like to detect the target 6 appearing in the captured image SG and to detect the relative position of the target 6.

When the target 6 is detected, the target detection unit 101 outputs data indicating the relative position of the detected target 6 with respect to the vehicle 1 to the risk-degree calculation unit 104.

Moreover, when the target 6 is detected, the target detection unit 101 outputs the data indicating the relative position of the detected target 6 with respect to the vehicle 1 and data indicating a position of the detected target 6 in the captured image to the display control unit 105.

### 1-2. Sight-Line Detection Unit

The sight-line detection unit 102 detects the direction of the line of sight of the driver U. The sight-line detection unit 102 detects the direction of the line of sight of the driver U, based on image data on a captured image received from the driver monitoring camera 9. The sight-line detection unit 102 detects the eyes of the driver U, through pattern matching or based on color or the like, from the captured image acquired by capturing by the driver monitoring camera 9, and detects a direction in which the detected eyes are pointing as the direction of the line of sight. Note that data (for example, eye shape data or color data) required to detect an eye is stored in the memory 110.

When the direction of the line of sight of the driver U is detected, the sight-line detection unit 102 outputs data indicating the detected direction of the line of sight to the display control unit 105.

### 1-3. Head Detection Unit

The head detection unit 103 detects the head HD of the driver U sitting in the driver seat. The head detection unit 103 detects the head HD of the driver U, based on image data on a captured image received from the driver monitoring camera 9. The head detection unit 103 detects the head HD, through pattern matching or based on color or the like, from the captured image acquired by capturing by the driver monitoring camera 9. Next, the head detection unit 103 detects a position of the head HD in the captured image. The head detection unit 103 then detects a position of the head HD in the vehicle 1 when the vehicle 1 is viewed from above, based on the size of the head HD appearing in the captured image and the position of the head HD in the captured image. Note that it has been determined, through testing or simulation performed beforehand, what position the head HD is at in the vehicle 1 when how big the head HD is in a captured image and what position the head HD is at in the captured image, and such information is stored as data in the memory 110.

### 1-4. Risk-Degree Calculation Unit

The risk-degree calculation unit 104 calculates a degree of risk that is a degree of probability of the vehicle 1 coming into contact with a target 6.

For example, the risk-degree calculation unit 104 calculates the separation distance between the vehicle 1 and the target 6, based on data indicating a relative position received from the target detection unit 101. Next, the risk-degree calculation unit 104 calculates an evaluation value corresponding to the calculated separation distance, among evaluation values on multi-point scale, as the degree of risk. In the present embodiment, the degree of risk is any one of evaluation values on 11-point scale ranging from “0” to “10”, and a larger point on the scale (a larger number in double-quotation marks) indicates a higher degree of risk. For example, a degree of risk of “0” indicates that there is no risk. For example, “10” indicates the highest degree of risk. In the case of such a calculation method, the risk-degree calculation unit 104 calculates a degree of risk corresponding to a larger point on the scale, for a shorter separation distance calculated.

Note that “0” is an example of “a predetermined value at which it is possible to deem that there is no probability of contact with the target”.

Alternatively, for example, the risk-degree calculation unit 104 calculates the mutual relative velocities of the vehicle 1 and the target 6, based on data indicating a plurality of relative positions received from the target detection unit 101 and a result of detection by the vehicle speed sensor 11. Moreover, the risk-degree calculation unit 104 calculates the separation distance between the vehicle 1 and the target 6, based on data indicating a relative position received from the target detection unit 101. Next, the risk-degree calculation unit 104 calculates a time period required for the vehicle 1 to come into contact with the target 6, based on the calculated relative velocities and separation distance. The risk-degree calculation unit 104 then calculates an evaluation value corresponding to the calculated required time period, among evaluation values on 11-point scale, as the degree of risk. In the case of such a calculation method, the risk-degree calculation unit 104 calculates a degree of risk corresponding to a larger point on the scale, for a shorter required time period calculated.

Alternatively, for example, when a vehicle-to-vehicle communication apparatus and a GNSS unit are connected to the sight-line guidance apparatus 7 and when the target 6 detected by the target detection unit 101 is another vehicle, the risk-degree calculation unit 104 may calculate the degree of risk as follows. Specifically, the risk-degree calculation unit 104 calculates the mutual relative velocities of the vehicle 1 and the target 6 and the separation distance between the vehicle 1 and the target 6, based on the speed of the vehicle 1 detected by the vehicle speed sensor 11, the position of the vehicle 1 received by the GNSS unit, and the position of the other vehicle and the speed of the other vehicle received by the vehicle-to-vehicle communication apparatus. Next, the risk-degree calculation unit 104 calculates a time period required for the vehicle 1 to come into contact with the target 6, based on the calculated relative velocities and separation distance. The risk-degree calculation unit 104 then calculates an evaluation value corresponding to the calculated required time period, among evaluation values on 11-point scale, as the degree of risk. In the case of such calculation of a degree of risk, the risk-degree calculation unit 104 calculates a degree of risk corresponding to a larger point on the scale, for a shorter required time period calculated.

Note that the above-described methods of calculating a degree of risk are only examples, and a method of calculating a degree of risk is not limited to the described methods.

When the degree of risk is calculated, the risk-degree calculation unit 104 outputs data indicating the calculated degree of risk to the display control unit 105.

### 1-5. Display Control Unit

The display control unit 105 displays a sight-line guidance sign VI on the windshield 3 by controlling operation of the HUD 5. The display control unit 105 displays the sight-line guidance sign VI on the windshield 3 and, in the windshield 3, moves the sight-line guidance sign VI displayed on the windshield 3, by performing following processing.

The processing by the display control unit 105 is described with reference to FIG. 3.

FIG. 3 is a diagram for describing the processing by the display control unit 105.

The display control unit 105 detects a position of the line of sight (hereinafter, referred to as “sight-line position P1” with sign “P1” added) of the driver U in the windshield 3, based on the direction of the line of sight indicated by data received from the sight-line detection unit 102. For example, when the memory 110 stores data on the directions of the lines of sight of drivers U and sight-line positions P1 of the drivers U in the windshield 3 that are associated with each other, the display control unit 105 detects the sight-line position P1 of the driver U in the windshield 3 by referring to the data.

The display control unit 105 determines whether the detected sight-line position P1 of the driver U exists within the display-allowed area A1. The memory 110 stores data indicating the position of the display-allowed area A1 in the windshield 3. The display control unit 105 determines whether the detected sight-line position P1 of the driver U exists within the display-allowed area A1 by referring to the data stored in the memory 110.

When the display control unit 105 determines that the detected sight-line position P1 of the driver U exists within the display-allowed area A1, the display control unit 105 determines, as a display start position P2 of the sight-line guidance sign VI, a position that is a predetermined distance L2 away from the sight-line position P1 of the driver U, as shown in FIG. 3. Note that the display control unit 105 determines the display start position P2 by loading, into the memory 110, a coordinate system in which the shape, size, and up-down, right-left directions of the display-allowed area A1 are defined, and referring to the loaded coordinate system.

It is preferable that the predetermined distance L2 be a distance that positions the display start position P2 within a range including a central visual field centered on the sight-line position P1. For example, the predetermined distance L2 is a distance that positions the display start position P2 at a position on a circle that satisfies a vertical visual field of five degrees and a horizontal visual field of five degrees from the line of sight of the driver U. Note that the position on the circle that satisfies the vertical visual field of five degrees and the horizontal visual field of five degrees from the line of sight of the driver U is a position within the range of an effective visual field centered on the sight-line position P1. Although FIG. 3 illustrates a configuration in which the display start position P2 below and to the left of the sight-line position P1 is determined, the position of the display start position P2 may be, for example, below and to the right of the sight-line position P1, above and to the right of the sight-line position P1, or above and to the left of the sight-line position P1.

When the display start position P2 is determined, the display control unit 105 determines a movement end position P3 of the sight-line guidance sign VI. Note that the display control unit 105 determines the movement end position P3 by loading, into the memory 110, a coordinate system in which the shape, size, and up-down, right-left directions of the display-allowed area A1 are defined, and referring to the loaded coordinate system.

In the determination of the movement end position P3, the display control unit 105 determines a movement end position P3 in the up-down direction of the display-allowed area A1 (hereinafter, referred to as “first movement end position P3-1” with sign “P3-1” added). Note that the up-down direction of the display-allowed area A1 corresponds to the up-down direction of the windshield 3 and the shorter-side direction of the display-allowed area A1.

Moreover, in the determination of the movement end position P3, the display control unit 105 determines a movement end position P3 in the right-left direction of the display-allowed area A1 (hereinafter, referred to as “second movement end position P3-2” with sign “P3-2” added). Note that the right-left direction of the display-allowed area A1 corresponds to the right-left direction of the windshield 3 and the longer-side direction of the display-allowed area A1.

First, the determination of the first movement end position P3-1 is described.

The display control unit 105 obtains a position of the target 6 in the up-down direction of a captured image SG from data outputted by the target detection unit 101. The up-down direction of the captured image SG is a direction corresponding to the up-down direction of a scene appearing in the captured image SG. Next, the display control unit 105 translates the obtained position of the target 6 into a position in the up-down direction of the windshield 3. Note that the relationship between the position of the target 6 in the up-down direction of the captured image SG and the position in the up-down direction of the windshield 3 has been obtained through a simulation or the like beforehand, and is stored as data in the memory 110.

When the translated position is a position upper than an upper end JT of the display-allowed area A1 in the windshield 3, the display control unit 105 determines that the position of the upper end JT of the display-allowed area A1 is the first movement end position P3-1.

When the translated position is a position lower than a lower end KT of the display-allowed area A1 in the windshield 3, the display control unit 105 determines that the position of the lower end KT of the display-allowed area A1 is the first movement end position P3-1.

When the translated position is a position between the upper end JT and the lower end KT of the display-allowed area A1 in the windshield 3, the display control unit 105 determines that the translated position is the first movement end position P3-1.

Note that FIG. 3 illustrates a case in which the translated position is a position between the upper end JT and the lower end KT of the display-allowed area A1 in the windshield 3.

Next, the determination of the second movement end position P3-2 is described.

The display control unit 105 determines the second movement end position P3-2, based on the detected relative position of the target 6 and the detected position of the head HD.

FIG. 4 is a diagram for describing the determination of the second movement end position P3-2.

FIG. 4 illustrates, as the target 6, a pedestrian existing in front of the vehicle 1.

The display control unit 105 detects, in a view of the vehicle 1 from above, a position where a line connecting the position of the head HD of the driver U and the position of the target 6 intersects with the windshield 3 in the right-left direction of the vehicle 1. The display control unit 105 detects the position in the right-left direction at which the line connecting the position of the head HD and the position of the target 6 intersects with the windshield 3, based on the relative position of the target 6 detected by the target detection unit 101 and the position of the head HD detected by the head detection unit 103.

In FIG. 4, a line L3 is the line connecting the position of the head HD and the position of the target 6 in the view of the vehicle 1 from above. In the case of FIG. 4, the display control unit 105 detects a position P4 in the right-left direction at which the line L3 intersects with the windshield 3 in the view of the vehicle 1 from above.

Returning to the description of the second movement end position P3-2 with reference to FIG. 3, when the position of the intersection in the right-left direction is detected, the display control unit 105 determines that the position of a left end ST of the display-allowed area A1 is the second movement end position P3-2 when the detected position is on the left side of the left end ST of the display-allowed area A1 in the windshield 3.

When the position of the intersection in the right-left direction is detected, the display control unit 105 determines that the position of a right end UT of the display-allowed area A is the second movement end position P3-2 when the detected position is on the right side of the right end UT of the display-allowed area A1 in the windshield 3.

When the position of the intersection in the right-left direction is detected, the display control unit 105 determines that the detected position is the second movement end position P3-2 when the detected position is a position between the left end ST and the right end UT of the display-allowed area A1 in the windshield 3.

Note that FIG. 3 illustrates a case in which the position of the intersection in the right-left direction is a position between the right end UT and the left end ST of the display-allowed area A1.

When the first movement end position P3-1 and the second movement end position P3-2 are determined, the display control unit 105 determines, as the movement end position P3, a position determined by the first movement end position P3-1 and the second movement end position P3-2.

The display control unit 105 moves the sight-line guidance sign VI from the determined display start position P2 to the determined movement end position P3, which will be more clearly described later. The display control unit 105 determines the movement end position P3 as described above, whereby, when the target 6 is in the display-allowed area A1 when seen from the driver U, the sight-line guidance sign VI can be moved to a position coinciding with the target 6 when seen from the driver U. Moreover, the display control unit 105 determines the movement end position P3 as described above, whereby, when the target 6 is not in the display-allowed area A1 when seen from the driver U, the sight-line guidance sign VI can be moved to the dotted line L1 that is the border between the display-allowed area A1 and the display-disallowed area A2.

After the display start position P2 and the movement end position P3 are determined, the display control unit 105 determines, based on data inputted from the risk-degree calculation unit 104, whether the degree of risk calculated by the risk-degree calculation unit 104 is more than a first threshold value, or is between the first threshold value and a second threshold value that is less than the first threshold value, or is less than the second threshold value and is not “0”.

The second threshold value is a threshold value that is less than the first threshold value. For example, the first threshold value is “7”, and the second threshold value is “3”.

### 1-5-1. When More than First Threshold Value

When the display control unit 105 determines that the degree of risk is more than the first threshold value, the display control unit 105 decides on a first mode, for a mode of changing movement speed used when moving the sight-line guidance sign VI from the display start position P2 to the movement end position P3.

The first mode is a mode of decelerating more as the target 6 is approached. In other words, the first mode is a mode of decelerating more as the movement end position P3 is approached. Deceleration rates may be liner, or may be non-liner.

When the first mode is decided for the mode of changing the movement speed of the sight-line guidance sign VI, the display control unit 105 linearly moves the sight-line guidance sign VI from the display start position P2 to the movement end position P3 in the windshield 3 in accordance with changes in movement speed in the first mode.

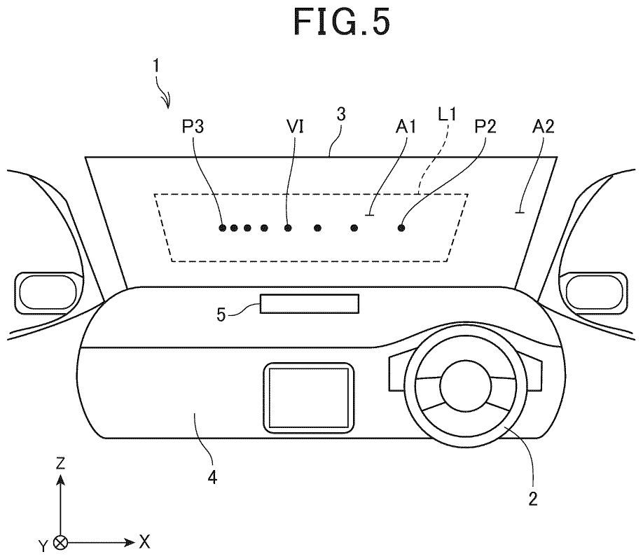

FIG. 5 shows an example of the movement of the sight-line guidance sign VI.

FIG. 5 shows a case in which the sight-line guidance sign VI is moved in accordance with changes in movement speed in the first mode. FIG. 5 illustrates a case in which the target 6 is within the display-allowed area A1 when seen from the driver U. Accordingly, in FIG. 5, the movement end position P3 is not on the dotted line L1 that is the border between the display-allowed area A1 and the display-disallowed area A2.

In FIG. 5, each of black circles is the sight-line guidance sign VI. In FIG. 5, the plurality of black circles indicates the positions of the sight-line guidance sign VI, each in a unit time period, in the movement from the display start position P2 to the movement end position P3. As shown in FIG. 5, according to changes in movement speed in the first mode, as the movement end position P3 is approached, the movement speed of the sight-line guidance sign VI decreases from a speed at the time of start of the movement, in the movement from the display start position P2 to the movement end position P3.

### 1-5-2. Between First Threshold Value and Second Threshold Value

When the display control unit 105 determines that the degree of risk is between the first threshold value and the second threshold value, the display control unit 105 decides on a second mode, for the mode of changing movement speed used when moving the sight-line guidance sign VI from the display start position P2 to the movement end position P3.

The second mode is a mode in which movement speed is the same, that is, a mode of constant speed. In other words, the second mode is a mode in which movement speed is unchanged up to the movement end position P3. Note that the movement speed in the second mode is lower than the initial speed for the movement in the first mode.

When the second mode is decided for the mode of changing the movement speed of the sight-line guidance sign VI, the display control unit 105 linearly moves the sight-line guidance sign VI from the display start position P2 to the movement end position P3 in the windshield 3 in accordance with changes in movement speed in the second mode.

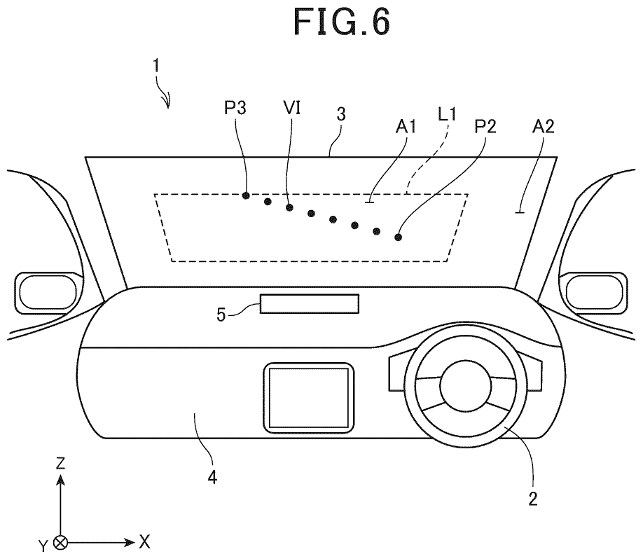

FIG. 6 shows an example of the movement of the sight-line guidance sign VI.

FIG. 6 shows a case in which the sight-line guidance sign VI is moved in accordance with changes in movement speed in the second mode. FIG. 6 illustrates a case in which the target 6 is not within the display-allowed area A1 when seen from the driver U. Accordingly, in FIG. 6, the movement end position P3 is on the dotted line L1 that is the border between the display-allowed area A1 and the display-disallowed area A2.

In FIG. 6, each of black circles is the sight-line guidance sign VI. In FIG. 6, the plurality of black circles indicates the positions of the sight-line guidance sign VI, each in a unit time period, in the movement from the display start position P2 to the movement end position P3. As shown in FIG. 6, according to changes in movement speed in the second mode, the movement speed of the sight-line guidance sign VI is constant in the movement from the display start position P2 to the movement end position P3.

### 1-5-3. When Less than Second Threshold Value

When the display control unit 105 determines that the degree of risk is less than the second threshold value and is not “0”, the display control unit 105 decides on a third mode, for the mode of changing movement speed used when moving the sight-line guidance sign VI from the display start position P2 to the movement end position P3.

The third mode is a mode of accelerating more as the target 6 is approached. In other words, the third mode is a mode of accelerating more as the movement end position P3 is approached. Acceleration rates may be liner, or may be non-liner.

When the third mode is decided for the mode of changing the movement speed of the sight-line guidance sign VI, the display control unit 105 linearly moves the sight-line guidance sign VI from the display start position P2 to the movement end position P3 in the windshield 3 in accordance with changes in movement speed in the third mode.

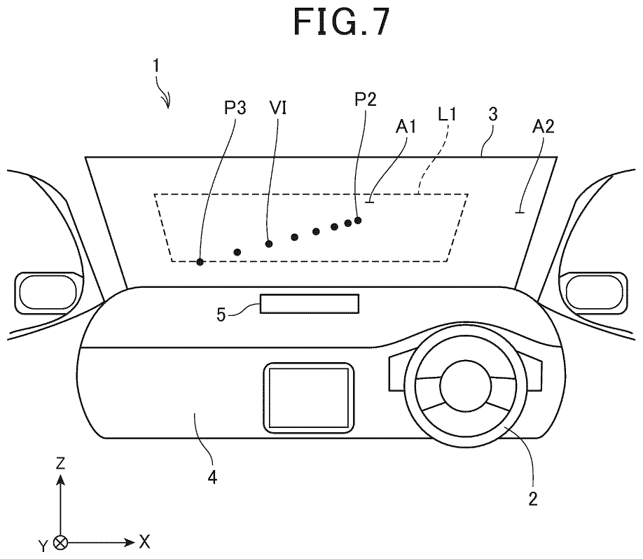

FIG. 7 shows an example of the movement of the sight-line guidance sign VI.

FIG. 7 shows a case in which the sight-line guidance sign VI is moved in accordance with changes in movement speed in the third mode. FIG. 7 illustrates a case in which the target 6 is not within the display-allowed area A1 when seen from the driver U. Accordingly, in FIG. 7, the movement end position P3 is on the dotted line L1 that is the border between the display-allowed area A1 and the display-disallowed area A2.

In FIG. 7, each of black circles is the sight-line guidance sign VI. In FIG. 7, the plurality of black circles indicates the positions of the sight-line guidance sign VI, each in a unit time period, in the movement from the display start position P2 to the movement end position P3. As shown in FIG. 7, according to changes in movement speed in the third mode, as the movement end position P3 is approached, the movement speed of the sight-line guidance sign VI increases from a speed at the time of start of the movement, in the movement from the display start position P2 to the movement end position P3.

### 1-5-4. When Degree of Risk Turns “0”

When the degree of risk calculated by the risk-degree calculation unit 104 turns “0” before the movement end position P3 is reached after the movement of the sight-line guidance sign VI is started, the display control unit 105 moves the sight-line guidance sign VI back to the display start position P2. More specifically, the display control unit 105 moves the sight-line guidance sign VI to the display start position P2 from a position at a time the degree of risk turns “0”.

The display control unit 105 moves the sight-line guidance sign VI back to the display start position P2 in such a manner that a movement speed corresponding to the separation distance between the display start position P2 and the sight-line guidance sign VI is the same movement speed that is used for the movement from the display start position P2.

For example, in the movement from the display start position P2, it is assumed that the movement speed of the sight-line guidance sign VI is “V1” when the separation distance between the display start position P2 and the sight-line guidance sign VI is “D1”. Moreover, in the movement from the display start position P2, it is assumed that the movement speed of the sight-line guidance sign VI is “V2” when the separation distance between the display start position P2 and the sight-line guidance sign VI is “D2”. Here, it is assumed that D1<D2 and V1>V2. In other words, the example above shows a case in which the sight-line guidance sign VI moves from the display start position P2 in accordance with changes in movement speed in the first mode. In the example, when the sight-line guidance sign VI is moved back to the display start position P2, the display control unit 105 displays the sight-line guidance sign VI in such a manner that the movement speed of the sight-line guidance sign VI is “V1” when the separation distance between the display start position P2 and the sight-line guidance sign VI is “D1”. When the separation distance between the display start position P2 and the sight-line guidance sign VI is “D2”, the display control unit 105 displays the sight-line guidance sign VI in such a manner that the movement speed of the sight-line guidance sign VI is “V2”.

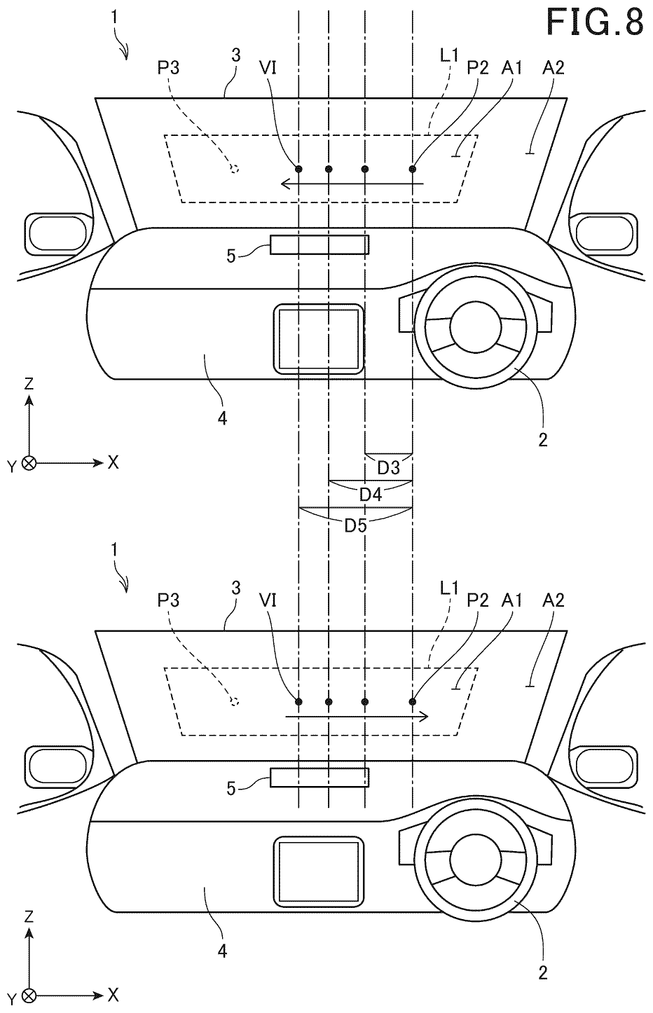

FIG. 8 is a diagram for describing the moving-back of the sight-line guidance sign VI.

FIG. 8 illustrates a case in which the degree of risk turns “0” when the sight-line guidance sign VI is being moved from the display start position P2 to the movement end position P3 shown in FIG. 5 in accordance with changes in movement speed in the first mode.

In FIG. 8, each of black circles is the sight-line guidance sign VI. In FIG. 8, the plurality of black circles indicates the positions of the sight-line guidance sign VI, each in a unit time period, in the movement from the display start position P2 to the movement end position P3 and from the movement end position P3 to the display start position P2.

An upper half of FIG. 8 shows the movement of the sight-line guidance sign VI from the display start position P2. A lower half of FIG. 8 shows the movement of the sight-line guidance sign VI back to the display start position P2.

When the sight-line guidance sign VI moves from the display start position P2 toward the movement end position P3, it is assumed that the movement speed of the sight-line guidance sign VI is “V3” when the separation distance from the display start position P2 is “D3”. In such a case, when the sight-line guidance sign VI moves back to the display start position P2, the movement speed of the sight-line guidance sign VI is “V3” when the separation distance from the display start position P2 is “D3”.

When the sight-line guidance sign VI moves from the display start position P2 toward the movement end position P3, it is assumed that the movement speed of the sight-line guidance sign VI is “V4” when the separation distance from the display start position P2 is “D4”. Note that D3<D4 and V3>V4. In such a case, when the sight-line guidance sign VI moves back to the display start position P2, the movement speed of the sight-line guidance sign VI is “V4” when the separation distance from the display start position P2 is “D4”.

When the sight-line guidance sign VI moves from the display start position P2 toward the movement end position P3, it is assumed that the movement speed of the sight-line guidance sign VI is “V5” when the separation distance from the display start position P2 is “D5”. Note that D4<D5 and V4>V5. In such a case, when the sight-line guidance sign VI moves back to the display start position P2, the movement speed of the sight-line guidance sign VI is “V5” when the separation distance from the display start position P2 is “D5”.

### 2. Operation of Sight-Line Guidance Apparatus

Next, operation of the sight-line guidance apparatus 7 according to the present embodiment is described.

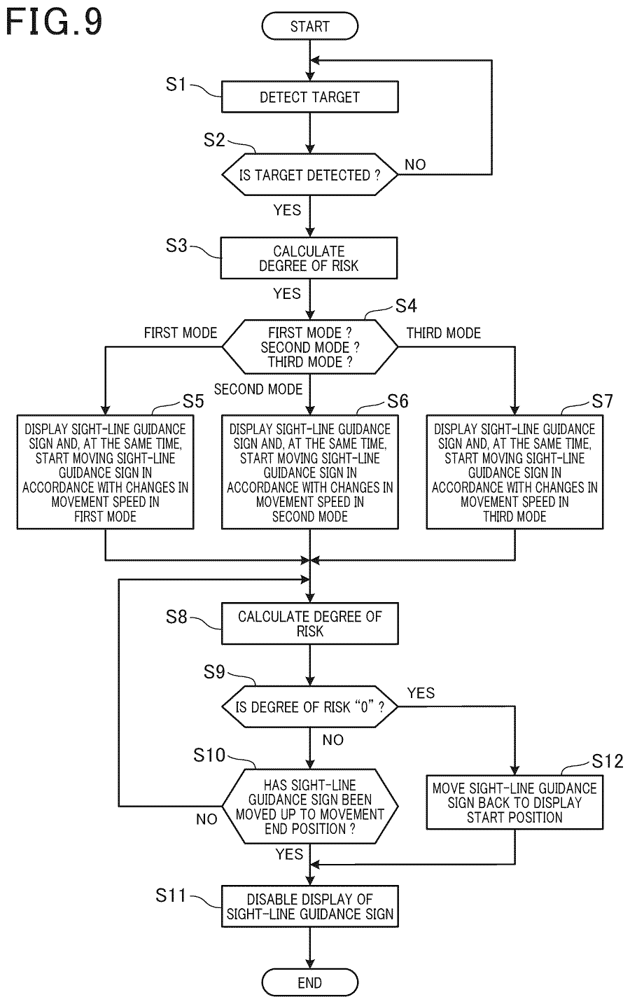

FIG. 9 is a flowchart showing the operation of the sight-line guidance apparatus 7.

The target detection unit 101 detects a target 6 existing in front of the vehicle 1 (step S1).

Step S1 corresponds to “first step”.

The risk-degree calculation unit 104 determines whether or not a target 6 is detected in step S1 (step S2). The determination in step S2 is performed based on whether or not the risk-degree calculation unit 104 receives data from the target detection unit 101.

When the risk-degree calculation unit 104 determines that a target 6 is not detected (step S2: NO), the processor 100 returns the processing to step S1, and the process in step S1 is performed again.

When the risk-degree calculation unit 104 determines that a target 6 is detected (step S2: YES), the risk-degree calculation unit 104 calculates a degree of risk related to the target 6 detected by the target detection unit 101 (step S3).

Subsequently, the display control unit 105 determines whether to decide on the first mode, to decide on the second mode, or to decide on the third mode, for the mode of changing the movement speed of the sight-line guidance sign VI (step S4). Step S4 is performed based on the degree of risk calculated in step S3.

When the display control unit 105 determines that the first mode is decided for the mode of changing the movement speed (step S4: first mode), the display control unit 105 displays the sight-line guidance sign VI and, at the same time, starts moving the sight-line guidance sign VI in accordance with changes in movement speed in the first mode (step S5).

Step S5 corresponds to “second step”.

Returning to the description of step S4, when the display control unit 105 determines that the second mode is decided for the mode of changing the movement speed (step S4: second mode), the display control unit 105 displays the sight-line guidance sign VI and, at the same time, starts moving the sight-line guidance sign VI in accordance with changes in movement speed in the second mode (step S6).

Step S6 corresponds to “second step”.

Returning to the description of step S4, when the display control unit 105 determines that the third mode is decided for the mode of changing the movement speed (step S4: third mode), the display control unit 105 displays the sight-line guidance sign VI and, at the same time, starts moving the sight-line guidance sign VI in accordance with changes in movement speed in the third mode (step S7).

Step S7 corresponds to “second step”.

Any one of steps S5, S6, S7 is executed, and when the sight-line guidance sign VI is moved to the movement end position P, the risk-degree calculation unit 104 calculates a degree of risk (step S8).

Subsequently, the display control unit 105 determines whether or not the degree of risk calculated in step S8 is “0” (step S9).

When it is determined that the degree of risk is not “0” (step S9: NO), the display control unit 105 determines whether or not the sight-line guidance sign VI has been moved up to the movement end position P3 (step S10).

When the display control unit 105 determines that the sight-line guidance sign VI has not been moved up to the movement end position P3 (step S10: NO), the processor 100 returns the processing to step S8, and step S8 is executed again.

When the display control unit 105 determines that the sight-line guidance sign VI has been moved up to the movement end position P3 (step S10: YES), the display control unit 105 disables the display of the sight-line guidance sign VI (step S11).

Returning to the description of step S9, when the display control unit 105 determines that the degree of risk is “0” (step S9: YES), the display control unit 105 moves the sight-line guidance sign VI back to the display start position P2 (step S12).

Subsequently, when the sight-line guidance sign VI has been moved back to the display start position P2, the display control unit 105 disables the display of the sight-line guidance sign VI (step S11).

### 3. Other Embodiments

The embodiment described above illustrates only an aspect, and any modifications and applications can be made.

Although the vehicle 1 that is a four-wheel automobile is illustrated as “vehicle” in the embodiment, the number of wheels is not limited to four as long as the “vehicle” includes a windshield 3.

In the embodiment, a configuration is made such that a degree of risk is calculated based on an evaluation value on an 11-point scale. In another embodiment, the number of points on the scale for degrees of risk is not limited to 11, and the number of points on the scale may be smaller than 11, or may be larger than 11.

Although “0” is illustrated as the predetermined value of degree of risk at which it is possible to deem that there is no probability of contact with a target 6 in the embodiment, the predetermined value may be, for example, “1” or “2”, as long as the value is less than the second threshold value.

In the embodiment, a configuration is made such that the HUD 5 is used to display the sight-line guidance sign VI on the windshield 3. However, means for displaying the sight-line guidance sign VI may be any means for displaying a virtual image on the windshield 3, not limited to the HUD 5, and may be, for example, an LED (Light Emitting Diode) or other display means.

The processor 100 may be configured by using a plurality of processors, or may be configured by using a single processor. The processor 100 may be hardware programmed to implement the functional units described above. In such a case, the processor 100 is configured by using, for example, an ASIC (Application Specific Integrated Circuit) or an FPGA (Field Programmable Gate Array).

The configuration as to each unit of the vehicle 1 shown in FIG. 2 is an example, and a specific implementation form is not limited particularly. In other words, an individual corresponding hardware piece does not necessarily need to be mounted for each unit, and it is also certainly possible to make a configuration such that the function of each unit is implemented by a single processor executing a program. In the embodiment, one or some of the functions implemented by using software may be configured as hardware, or alternatively, one or some of the functions implemented by hardware may be implemented by using software.

Furthermore, the step units of operation shown in FIG. 9 are created by division according to main processes, and the present invention is not limited by a way of division into, or by names of, units of processing. The operation may be divided into more step units according to processes. A step unit may be divided to include more sub-processes. The order of steps may be interchanged as appropriate to the extent that the gist of the present invention is not impaired.

When a sight-line guidance method by the sight-line guidance apparatus 7 is implemented by using the processor 100, the program to be executed by the processor 100 can also be configured in the form of a recording medium or a transmission medium transmitting the program. In other words, the control program 111 can also be implemented in a state in which the control program 111 is recorded on a removable information recording medium. Examples of the information recording medium include magnetic recording media such as hard disk, optical recording media such as CD, and semiconductor storage devices such as USB (Universal Serial Bus) memory and SSD (Solid State Drive). Any other recording medium can also be used.

### 4. Configurations Supported by the Embodiment

The embodiment supports following configurations.

### Configuration 1

A sight-line guidance apparatus that guides a line of sight of a driver of a vehicle, including: a first detection unit that detects a target existing in front of the vehicle; and a display control unit that displays a sight-line guidance sign on a windshield of the vehicle when the first detection unit detects the target, the sight-line guidance sign guiding the line of sight of the driver to the target, wherein the display control unit displays the sight-line guidance sign in such a manner that the sight-line guidance sign moves from a display start position of the sight-line guidance sign toward the target in accordance with a change in movement speed, the change being made based on a degree of risk that is a degree of probability of the vehicle coming into contact with the target.

According to the sight-line guidance apparatus in configuration 1, changes in the movement speed of the sight-line guidance sign can be varied according to the degree of risk. Accordingly, the driver can perceive, from the changes in the movement speed of the sight-line guidance sign, how probable it is that the vehicle comes into contact with the target. Accordingly, the driver can perceive what situation the own vehicle is in, in terms of contact with the target. Moreover, since the driver can perceive what situation the own vehicle is in, in terms of contact with the target, at a time while the sight-line guidance sign is moving, the driver can quickly perceive what situation the own vehicle is in, in terms of contact with the target.

### Configuration 2

When the target is in a first area in which display of the sight-line guidance sign is allowed, the display control unit moves the sight-line guidance sign to a position at which coincidence with the target occurs, and when the target is not in the first area, the display control unit moves the sight-line guidance sign to a border between the first area and a second area in which display of the sight-line guidance sign is disallowed.

According to the sight-line guidance apparatus in configuration 2, when the target is in the area in which display of the sight-line guidance sign is allowed, the sight-line guidance sign is moved to a position at which coincidence with the target occurs. Accordingly, the possibility can be enhanced that the line of sight of the driver can be guided to the target. Humans have a characteristic of, even if movement of a sight-line guidance sign is stopped halfway, directing the line of sight beyond the stop in the direction of the movement of the sight-line guidance sign. Based on such a characteristic, according to the sight-line guidance apparatus in configuration 2, when the target is not in the area in which display of the sight-line guidance sign is allowed, the sight-line guidance sign is moved to an end of the area in the direction toward the target. Accordingly, the possibility can be enhanced that the line of sight of the driver can be guided to the target even if the target is not in the area in which display of the sight-line guidance sign is allowed. Accordingly, according to the sight-line guidance apparatus in configuration 2, the possibility can be enhanced that the line of sight of the driver can be guided to the target.

### Configuration 3

The sight-line guidance apparatus according to configuration 1 or 2, wherein based on the degree of risk, the display control unit decides on any one of a first mode of decelerating more as the target is approached, a second mode of unchanging the movement speed, and a third mode of accelerating more as the target is approached, for a mode of changing the movement speed of the sight-line guidance sign.

According to the sight-line guidance apparatus in configuration 3, the driver can perceive how probable it is that the vehicle comes into contact with the target on a three-point scale, for example, that the probability of the vehicle coming into contact with the target is high, medium, or low. Accordingly, the driver does not need to have learned many patterns of what form of change in the movement speed of the sight-line guidance sign indicating what degree of risk. Accordingly, the driver can easily and quickly perceive what situation the own vehicle is in, in terms of contact with the target.

### Configuration 4

The sight-line guidance apparatus according to configuration 3, wherein the display control unit decides on the first mode when the degree of risk is more than a first threshold value, decides on the second mode when the degree of risk is between the first threshold value and a second threshold value that is less than the first threshold value, and decides on the third mode when the degree of risk is less than the second threshold value.

Humans have a characteristic of directing the line of sight to a thing making greater movement. Based on such a characteristic, according to the sight-line guidance apparatus in configuration 4, when the degree of risk is more than the first threshold value, the driver can quickly notice the sight-line guidance sign, so that the line of sight of the driver can be quickly guided. Moreover, according to the sight-line guidance apparatus in configuration 4, when the degree of risk is less than the second threshold value, the movement of the sight-line guidance sign increases as the target is approached. Accordingly, the degree of certainty of guiding the line of sight of the driver to the target can be enhanced.

### Configuration 5

The sight-line guidance apparatus according to any one of configurations 1 to 4, wherein the display control unit moves the sight-line guidance sign back to the display start position when the degree of risk becomes a predetermined value or less after the sight-line guidance sign is moved, the predetermined value being a value at which it is possible to deem that there is no probability of contact with the target.

According to the sight-line guidance apparatus in configuration 5, as a result of the moving sight-line guidance sign moving back to the display start position, the driver can easily perceive that the probability of the vehicle coming into contact with the target turns nil.

### Configuration 6

The sight-line guidance apparatus according to configuration 5, wherein the display control unit moves the sight-line guidance sign back to the display start position in such a manner that a movement speed according to a separation distance between the display start position and the sight-line guidance sign is equal to a movement speed used for the movement from the display start position.

According to the sight-line guidance apparatus in configuration 6, the sight-line guidance sign is moved back in accordance with the same changes in movement speed as in the mode that is used for the movement from the display start position, whereby the driver can more easily perceive that the probability of contact with the target to which the sight-line guidance sign has guided turns nil.

### Configuration 7

The sight-line guidance apparatus according to any one of configurations 1 to 6, further including a second detection unit that detects a position of the line of sight of the driver in the windshield, wherein the display start position is a position that is a predetermined distance away from the position of the line of sight of the driver detected by the second detection unit.

Humans have a characteristic of more easily noticing a sign appearing at a position off the line of sight. Based on such a characteristic, according to the sight-line guidance apparatus in configuration 7, the driver can quickly notice the sight-line guidance sign, so that the line of sight of the driver can be quickly guided.

### Configuration 8

A sight-line guidance method of guiding a line of sight of a driver of a vehicle, including: a first step of detecting a target existing in front of the vehicle; and a second step of displaying a sight-line guidance sign on a windshield of the vehicle when the target is detected in the first step, the sight-line guidance sign guiding the line of sight of the driver to the target, wherein the second step displays the sight-line guidance sign in such a manner that the sight-line guidance sign moves from a display start position of the sight-line guidance sign toward the target in accordance with a change in movement speed, the change being made based on a degree of risk that is a degree of probability of the vehicle coming into contact with the target.

According to the sight-line guidance method in configuration 8, similar effects to those of the sight-line guidance apparatus in configuration 1 can be brought about.

### Configuration 9

A non-transitory computer readable recording medium recording a program for a sight-line guidance apparatus that guides a line of sight of a driver of a vehicle, the program causing a processor of the sight-line guidance apparatus to function as: a first detection unit that detects a target existing in front of the vehicle; and a display control unit that displays a sight-line guidance sign on a windshield of the vehicle when the first detection unit detects the target, the sight-line guidance sign guiding the line of sight of the driver to the target, wherein the display control unit displays the sight-line guidance sign in such a manner that the sight-line guidance sign moves from a display start position of the sight-line guidance sign toward the target in accordance with a change in movement speed, the change being made based on a degree of risk that is a degree of probability of the vehicle coming into contact with the target.

According to the recording medium in configuration 9, similar effects to those of the sight-line guidance apparatus in configuration 1 can be brought about.

### REFERENCE SIGNS LIST

1 vehicle
2 steering wheel
3 windshield
4 instrument panel
5 HUD
6 target
7 sight-line guidance apparatus
8 front camera
9 driver monitoring camera
10 position detection device
11 vehicle speed sensor
100 processor
101 target detection unit (first detection unit)
102 sight-line detection unit (second detection unit)
103 head detection unit
104 risk-degree calculation unit
110 memory
111 control program (program)
HD head
JT upper end
KT lower end
L1 dotted line
L3 line
P1 sight-line position
P2 display start position
P3 movement end position
P3-1 first movement end position
P3-2 second movement end position
P4 position
S1 step (first step)
S2 to S4 step
S5 to S7 step (second step)
S8 to S12 step
SG captured image
ST left end
U driver
UT right end
VI sight-line guidance sign

1. A sight-line guidance apparatus that guides a line of sight of a driver of a vehicle, comprising:
a first detection unit that detects a target existing in front of the vehicle; and
a display control unit that displays a sight-line guidance sign on a windshield of the vehicle when the first detection unit detects the target, the sight-line guidance sign guiding the line of sight of the driver to the target,
wherein the display control unit displays the sight-line guidance sign in such a manner that the sight-line guidance sign moves from a display start position of the sight-line guidance sign toward the target in accordance with a change in movement speed, the change being made based on a degree of risk that is a degree of probability of the vehicle coming into contact with the target.

2. The sight-line guidance apparatus according to claim 1, wherein
when the target is in a first area in which display of the sight-line guidance sign is allowed, the display control unit moves the sight-line guidance sign to a position at which coincidence with the target occurs, and
when the target is not in the first area, the display control unit moves the sight-line guidance sign to a border between the first area and a second area in which display of the sight-line guidance sign is disallowed.

3. The sight-line guidance apparatus according to claim 1, wherein based on the degree of risk, the display control unit decides on any one of a first mode of decelerating more as the target is approached, a second mode of unchanging the movement speed, and a third mode of accelerating more as the target is approached, for a mode of changing the movement speed of the sight-line guidance sign.

4. The sight-line guidance apparatus according to claim 3, wherein the display control unit decides on the first mode when the degree of risk is more than a first threshold value, decides on the second mode when the degree of risk is between the first threshold value and a second threshold value that is less than the first threshold value, and decides on the third mode when the degree of risk is less than the second threshold value.

5. The sight-line guidance apparatus according to claim 1, wherein the display control unit moves the sight-line guidance sign back to the display start position when the degree of risk becomes a predetermined value or less during a period between when movement of the sight-line guidance sign starts and when the movement ends, the predetermined value being a value at which it is possible to deem that there is no probability of contact with the target.

6. The sight-line guidance apparatus according to claim 5, wherein the display control unit moves the sight-line guidance sign back to the display start position in such a manner that a movement speed according to a separation distance between the display start position and the sight-line guidance sign is equal to a movement speed used for the movement from the display start position.

7. The sight-line guidance apparatus according to claim 1, further comprising a second detection unit that detects a position of the line of sight of the driver in the windshield,
wherein the display start position is a position that is a predetermined distance away from the position of the line of sight of the driver detected by the second detection unit.

8. A sight-line guidance method of guiding a line of sight of a driver of a vehicle, comprising:
a first step of detecting a target existing in front of the vehicle; and
a second step of displaying a sight-line guidance sign on a windshield of the vehicle when the target is detected in the first step, the sight-line guidance sign guiding the line of sight of the driver to the target,
wherein the second step displays the sight-line guidance sign in such a manner that the sight-line guidance sign moves from a display start position of the sight-line guidance sign toward the target in accordance with a change in movement speed, the change being made based on a degree of risk that is a degree of probability of the vehicle coming into contact with the target.

9. A non-transitory computer readable recording medium recording a program for a sight-line guidance apparatus that guides a line of sight of a driver of a vehicle, the program causing a processor of the sight-line guidance apparatus to function as:
a first detection unit that detects a target existing in front of the vehicle; and
a display control unit that displays a sight-line guidance sign on a windshield of the vehicle when the first detection unit detects the target, the sight-line guidance sign guiding the line of sight of the driver to the target,
wherein the display control unit displays the sight-line guidance sign in such a manner that the sight-line guidance sign moves from a display start position of the sight-line guidance sign toward the target in accordance with a change in movement speed, the change being made based on a degree of risk that is a degree of probability of the vehicle coming into contact with the target.
